(19) United States
(12) Patent Application Publication
(10) Pub. No.: US 2021/0033705 A1
(43) Pub. Date: Feb. 4, 2021

(54) METHOD AND SYSTEM FOR EMITTING AND RECEIVING LASER PULSES

(71) Applicant: ArianeGroup SAS, Paris (FR)

(72) Inventors: Guy-Maël JACOBE DE NAUROIS, BR Den Haag (NL); David PARRAIN, Poissy (FR); Bruno ESMILLER, Villennes Sur Seine (FR)

(21) Appl. No.: 17/044,444

(22) PCT Filed: Mar. 28, 2019
(86) PCT No.: PCT/FR2019/050719

§ 371 Date: Oct. 1, 2020

(30) Foreign Application Priority Data
Apr. 3, 2018 (FR) 1800272

(51) Int. Cl. G01S 7/487; G01S 17/10

(52) U.S. Cl. CPC G01S 7/487; G01S 7/4876; G01S 17/10

(57) ABSTRACT

The system includes a generating unit for generating a pattern of pulses including at least three pulses, two successive pulses of the pattern of pulses being in each case temporarily separated by an associated separation duration, the various separation durations of the pattern of pulses being variable, an emitting/receiving unit including an emitting module for emitting a set of pulses having said pattern of pulses and a receiving module for receiving the light pulses, a memory for recording the reception times at which the light pulses are received by the receiving module, and a processing module for analysing the durations between the reception times of the light pulses in order to identify a sequence of received light pulses, which has said pattern of pulses, and to associate it with the emitted set of pulses.

### TECHNICAL FIELD

The present invention relates to a method and system for emitting and receiving laser pulses.

### PRIOR ART

Although not exclusively, a system for emitting and receiving laser pulses, as considered, may form part of a high-frequency laser telemeter that is in particular intended to be used in various applications in the space field.

Such a laser telemeter may, in particular, be used for implementing laser trajectography or laser telemetry on a satellite of the SLR. (standing for Satellite Laser Ranging) type. The great increase in debris in orbit and the development of threats are spurring on the development of optical means, in particular active optical means of the laser trajectography type, in order to know very precisely the orbits of space objects (satellites, debris).

Moreover, another possible application of a system for emitting and receiving laser pulses, at high frequency, is to implement a laser communication link between a ground station and a drone (or an object or craft in orbit) using a modulated retroreflector technology. To do this, provision is made, in the ground station, for the laser system intended to emit a laser beam in order to illuminate a retroreflector mounted on the drone (or on the object or craft in orbit). This retroreflector is designed to modulate the reflected intensity. It is constructed (in the form of a cube corner or a spherical reflector for example) so that the laser beam is reflected exactly in the same direction as that of the laser beam received. The modulation is detected and processed by the system on the ground.

Other applications are also possible for such a system for emitting and receiving laser pulses.

For these applications, by emitting low-energy laser pulses (less than 1 mJ), which is limited for safety reasons, the difficulty is being able to process the signals, because of ratios between the return signals and noise, which are extremely small.

Usually, single pulses of medium energies (greater than 0.1 mJ) are emitted. However, if it is attempted to increase the firing rate, the spatial resolution of the measurement is degraded, or even impossible if firing is carried out continuously at high frequency (more quickly than the round-trip time of the pulses).

### DISCLOSURE OF THE INVENTION

The object of the present invention is to remedy these drawbacks by proposing a method for emitting and receiving laser pulses making it possible to increase the firing rate (and thus the probability of detection).

According to the invention, said method for emitting and receiving laser pulses includes at least the following steps:
a step of generating at least one pattern of pulses, implemented by a generating unit, said pattern of pulses comprising at least three successive pulses, two successive pulses of said pattern of pulses being on each occasion separated in time by an associated separation duration, the various separation durations of the pattern of pulses being variable and in accordance with a given model;
an emission step, implemented by an emitting/receiving unit, consisting in emitting at least one set of pulses comprising a sequence of laser pulses in accordance with said pattern of pulses and recording at least the so-called sending time, at which the first pulse in the sequence of laser pulses in said set of pulses is emitted;
a reception step, implemented by the emitting/receiving unit, consisting in receiving light pulses and recording the so-called reception times at which these light pulses are received; and
an analysis step, implemented by a data processing unit, consisting at least in analysing the durations between the times of reception of the light pulses received at the reception step in order to identify a sequence of light pulses received, which is in accordance with said pattern of pulses.

Advantageously, the analysis step consists in deducing, from the sequence of pulses identified, a so-called reception time at which the first pulse in said sequence of pulses identified is received, and calculating the duration between said emission time and said reception time.

Thus, by means of the invention, it is possible to differentiate from each other the pulses in a set formed by a plurality of pulses by defining (timewise) the durations between, on each occasion, two successive pulses in order to make them unique within the set of pulses, in accordance with said pattern of pulses. It is possible consequently to emit sets (or packets) of pulses (in the form of a so-called burst emission mode), knowing that it is possible to identify the reception of the set of (returned) pulses, and in particular to determine the reception time at which the first pulse in said set of (returned) pulses is received.

This makes it possible in particular to increase the probability of detection by increasing the number of pulses, therefore using a set (or packet) of pulses instead of a single pulse.

The method for emitting and receiving laser pulses thus makes it possible, in particular, to reduce the energy of each laser pulse emitted (for example to 10 μJ), to distribute this energy in a plurality of laser pulses (forming the set of pulses) and to sign these laser pulses timewise (in accordance with the pattern of pulses). This makes it possible to emit at a higher firing rate in order to improve the probability of detection, while keeping great precision of emission in the case in particular of telemetry, and maintaining low average energy, which is favourable to ocular safety.

In a preferred embodiment, the analysis step consists in determining, by means of said duration between the emission time and the reception time, a distance between a station comprising the emitting/receiving unit and an object (or target) receiving the laser pulses emitted and returning them.

In a variant or as a complement, advantageously, the analysis step consists in analysing at least one set of pulses emitted and the corresponding sequence of pulses received, issuing for example from a modulation and a retroreflection, in order to deduce information therefrom, for example in the context of a laser link communicating with a drone or an object in orbit in space.

Moreover, advantageously, the analysis step consists in making a correlation between said pattern of pulses and the light pulses received on a correlation window in order to identify the sequence of light pulses received, which is in accordance with said pattern of pulses.

Preferably; the emission step consists in emitting, successively, a plurality of sets of pulses. Advantageously, the duration between two sets of pulses emitted successively is greater than a duration of round-trip movement of a set of pulses between a station comprising the emitting/receiving unit and an object receiving the laser pulses emitted and returning them.

Furthermore, in a particular embodiment, the generating step consists in generating at least two different patterns of pulses and the emission step consists in emitting a plurality of successive sets of pulses that are in accordance with different patterns of pulses; generated at the generating step.

The present invention also relates to a system for emitting and receiving laser pulses, including an emitting/receiving unit.

According to the invention, said system for emitting and receiving laser pulses includes:
a generating unit configured to generate at least one pattern of pulses, said pattern of pulses comprising at least three successive pulses, two successive pulses in said pattern of pulses being on each occasion separated in time by an associated separation duration, the various separation durations of the pattern of pulses being variable and in accordance with a given model;
the emitting/receiving unit that is configured to:
   emit at least one set of pulses comprising a sequence of laser pulses, in accordance with said pattern of pulses; and
   receive light pulses;
at least one memory configured to record at least the so-called reception times, at which the light pulses are received by the emitting/receiving unit; and
a data processing unit configured at least to analyse the durations between the times of reception of the light pulses in order to identify a sequence of light pulses received, which is in accordance with said pattern of pulses.

Advantageously, said memory is configured also to record a so-called emission time, at which the first pulse in the sequence of laser pulses in said set of laser pulses emitted by the emitting/receiving unit is emitted.

Furthermore, advantageously, the data processor unit is also configured:
to deduce, from the sequence of pulses identified, a so-called reception time at which the first pulse in said sequence of pulses identified is received, and to calculate the duration between said emission time and said reception time; and/or
to determine, by means of said duration between the emission time and the reception time, a distance between a station comprising the emitting/receiving unit and an object receiving the laser pulses emitted and returning them; and/or
to analyse at least one set of pulses emitted and the corresponding sequence of pulses received in order to deduce information therefrom.

Moreover, advantageously; said system for emitting and receiving laser pulses also includes at least one filtering unit configured to perform at least one frequency filtering of the light pulses received, in relation to the frequency or frequencies of the laser pulses emitted.

The present invention further relates to a laser telemeter and/or a communication system, including a system for emitting and receiving laser pulses as described above.

### BRIEF DESCRIPTION OF THE FIGURES

The accompanying figures will give a clear understanding of how the invention can be implemented. On these figures, identical references designate similar elements. More particularly:

FIG. 1 is a block diagram of a particular embodiment of a system for emitting and receiving laser pulses, according to the invention;

FIG. 2 is a schematic view of a pattern of pulses with three pulses;

FIG. 3 shows schematically two charts, placed one above the other, for explaining the functioning of an emitting/receiving unit of a system for emitting and receiving laser pulses;

FIGS. 4 to 7 illustrate schematically various successive steps of an analysis by correlation, with a view to identifying a sequence of light pulses received, which is in accordance with a pattern of pulses with four pulses; and

FIG. 8 is a block diagram of a method for emitting and receiving laser pulses.

### DETAILED DESCRIPTION

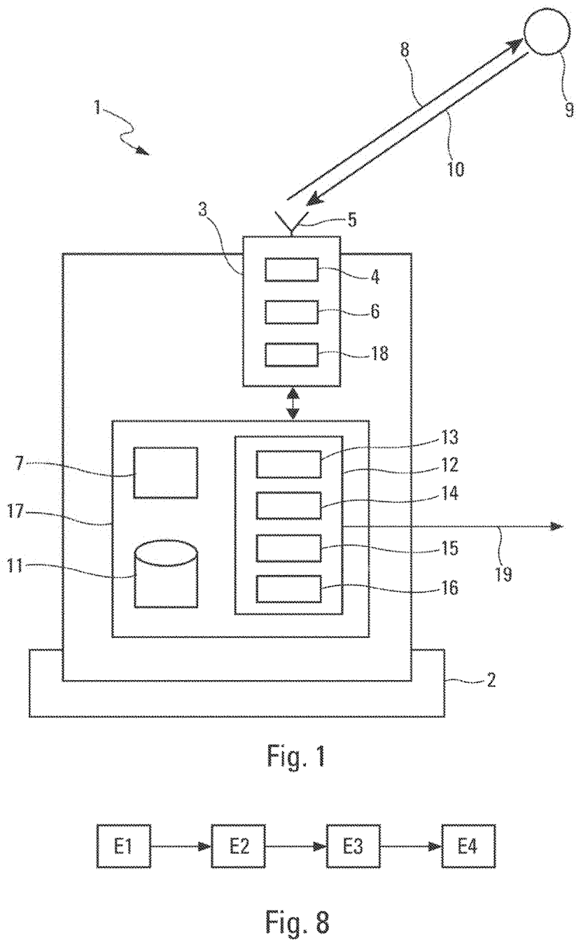

FIG. 1 shows a system for emitting and receiving laser pulses (hereinafter “system 1”) at high frequency, which is shown schematically in a particular embodiment.

This system 1, which is mounted on a station 2, installed for example on the ground, can be used in numerous applications, as indicated above. The system 1 may also be mounted on a land, sea or air vehicle (not shown).

The system 1 includes an emitting/receiving unit 3. The emitting/receiving unit 3 comprises, as shown in FIG. 1:
an emitting module 4 configured to emit laser pulses, via (emission/reception) lenses 5, for example laser pulses with a duration of around 0.3 ns; and
a receiving module 6 configured to receive (or detect) light pulses, and in particular laser pulses, via the (emission/reception) lenses 5.

According to the invention, said system 1 also includes, as shown in FIG. 1, a generating unit 7 that is configured to generate at least one pattern of pulses. The generating unit 7 comprises, for example, means enabling an operator to input characteristics of the pattern of pulses or means for automatically defining these characteristics.

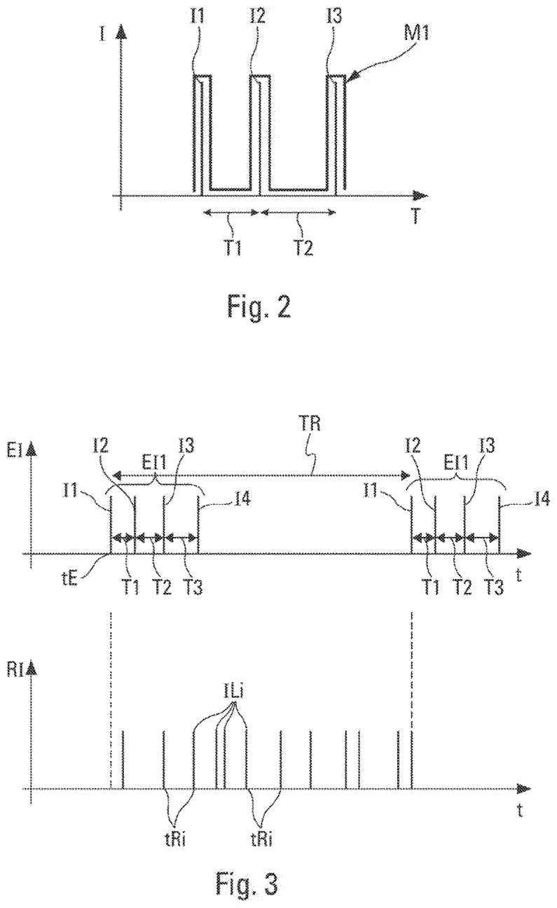

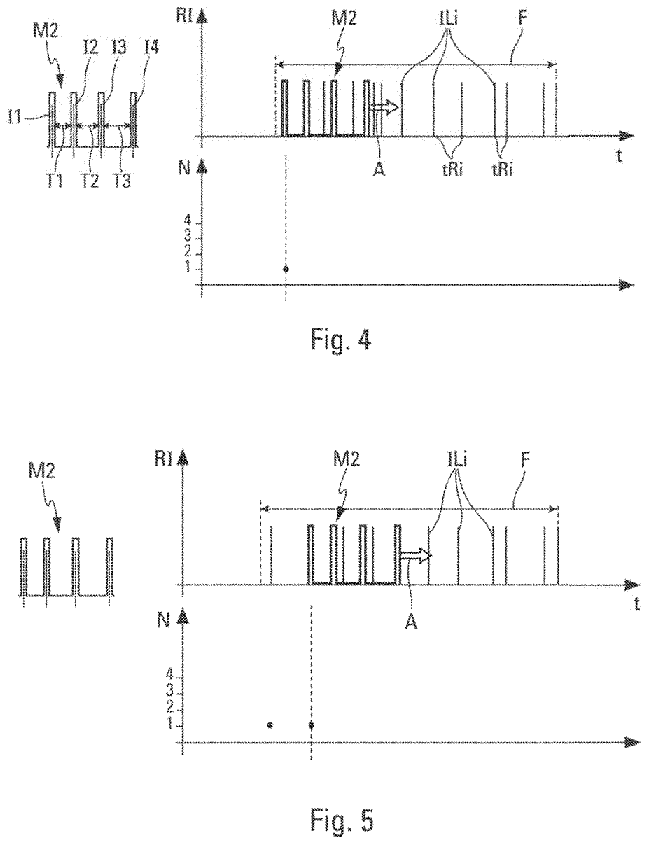

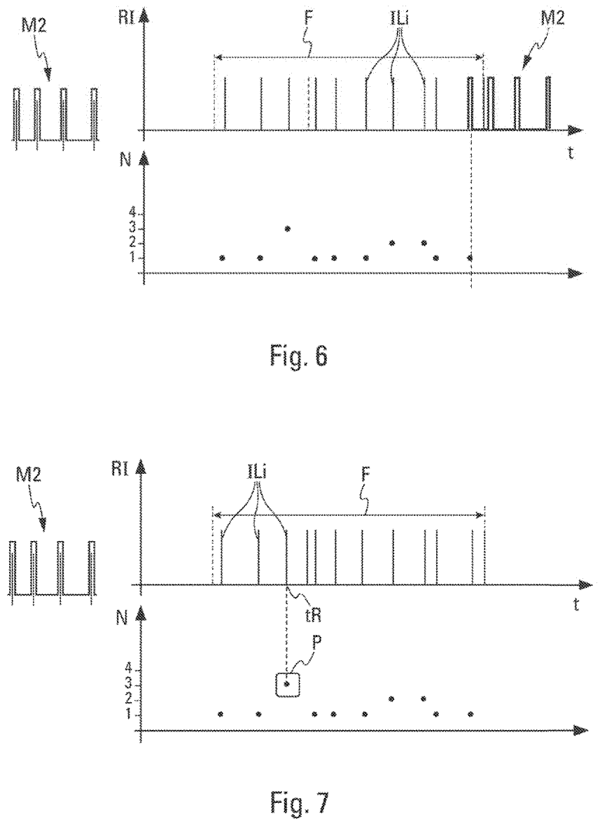

In the context of the present invention, a pattern of pulses comprises, as shown for a pattern of pulses M1 in FIG. 2, at least three successive pulses 1, namely the pulses I1, I2 and I3 on the example in FIG. 2. Although it preferably includes three pulses I1, I2 and I3, in particular for reasons of simplicity and speed of processing, the pattern of pulses used by the system 1 may also include more than three successive pulses, for example four pulses I1, I2, I3 and I4 as the pattern of pulses M2 in FIGS. 4 to 7, or more than four pulses.

Two directly successive pulses in the pattern of pulses are in each case separated in time by an associated separation duration, namely, in the example in FIG. 2, a separation duration T1 between the pulses I1 and I2 and a separation duration T2 between the pulses I2 and I3, and, in the example in FIG. 4, a further separation duration T3 between the pulses I3 and I4.

The various separation durations T1, T2 and T3 of the patterns of pulses M1 and M2 are variable, that is to say different from one another, and in accordance with a given model (of separation durations), that is to say each separation duration is equal to a particular duration. The pattern of pulses therefore represents a (time) signature of the pulses in question.

The emitting module 4 of the emitting/receiving unit 3 is configured to emit at least one set of pulses EI1 comprising a sequence of laser pulses, in accordance with the pattern of pulses in question, as shown in FIG. 3. By way of example, the set EI1 includes the sequence of pulses I1, I2, I3 and I4 (which in being emitted are separated in time in accordance with the pattern of pulses M2).

In addition, the receiving module 6 of the emitting/receiving unit 3 is configured to receive light pulses ILi (FIG. 3). Among the received pulses ILi, the receiving module 6 receives for example pulses corresponding to noises, and also the laser pulses which have been:
emitted by the emitting module 4, as illustrated by the arrow 8 in FIG. 1, for example in the form of the set EI1 (shown in FIG. 3); and then
returned by the object 9, for example a target, as illustrated by an arrow 10 in FIG. 1, before being detected by the receiving module 6.

This object 9 is preferably an object that is movable in the sky, for example a drone or a satellite (or any other object) in orbit. This object 9 may be situated at a great distance from the station 2, for example at several tens of kilometres from the station 2.

The system 1 also includes, as shown in FIG. 1, at least one memory 11 that is configured to record:
firstly the time (or moment referred to as the emission time tE, at which at least the first pulse 11 in the sequence of laser pulses in said set of pulses EI1 emitted by the emitting module 4 is emitted, as shown on the chart in the upper part of FIG. 3. This graph illustrates the emissions EI of pulses (made by the emitting module 4) as a function of the time t. In the example in FIG. 3, the sets of pulses EI1 are in accordance with the pattern of pulses M2 in FIGS. 4 to 7; and
secondly, the time (or moments), referred to as the reception (or detection) times tRi, at which the light pulses ILi are received (detected) by the receiving module 6 of the emitting/receiving unit 3, as shown on the graph in the lower part of FIG. 3. This graph illustrates the receptions RI of light pulses ILi as a function of the time t.

In a preferred embodiment, as shown in FIG. 3, the emitting module 4 is controlled so as to emit successively a plurality of sets of pulses EI1. The successive emissions are on each occasion separated by a so-called firing (or sending) duration TR, that is to say the emissions of the first pulses I1 of two sets EI1 emitted successively are separated by said firing duration TR.

The system 1 further includes a data processing unit 12. The data processing unit 12 comprises, as shown in FIG. 1, a processing element 13 that is configured to analyse the durations between the times of reception tRi of the various light pulses received by the receiving module 6, in order to identify a sequence of light pulses received, which is in accordance with the pattern of pulses used. The pattern of pulses used by the emitting module 4 is, for example, recorded in the memory 11. The sequence of pulses identified by the processing element 13 is such that the time of reception tRi of the light pulses IL of this sequence of light pulses are separated from each other by separation durations that are identical, to within a margin, to the separation durations T1 to T3 of the pattern of pulses used, and this in the same order of appearance.

To do this, the processing element 13 is configured to make a correlation between the pattern of pulses M2 used and the light pulses ILi received, on a correlation window F, in order to identify the sequence of light pulses received, which is in accordance with said pattern of pulses M2, as shown in FIGS. 4 to 7.

To make the correlation, the pattern of pulses M2 (with four pulses in this example) is moved, as illustrated by the arrow A in FIGS. 4 and 5, and, for each successive group of four successive pulses ILi received, the processing element 13 checks whether the durations between these four light pulses ILi (which are obtained from the corresponding reception times tRi) correspond to the separation durations T1 to T3 of the pattern of pulses M2. In the example in FIGS. 4 to 7, the number N of correspondences obtained for each correlation, that is to say for each successive group of four pulses, has been indicated on a chart provided in the lower part of these figures. In the example shown in these figures, the correlation makes it possible to identify a sequence of pulses where the first pulse is situated at a position P on FIG. 7, the position P being associated with the highest number N in the correlation.

Thus the system 1 is able to differentiate from each other the pulses in a set EI1 of a plurality of pulses by defining (timewise) the durations between, in each case, two successive (or consecutive) pulses in order to make them unique within the set of pulses EI1, in accordance with the pattern of pulses M1, M2 used.

Consequently the system 1 can emit sets (or packets) EI1 of pulses (in the form of a so-called burst emission mode), knowing that it will be able to identify the reception of the set of pulses emitted (and returned); and in particular to determine the reception time at which the first pulse in said set of pulses thus identified is received.

This makes it possible in particular to increase the probability of detection by increasing the number of pulses emitted, through the use of a set (or packet) EI1 of pulses instead of a single pulse.

Furthermore, the data processing unit 12 also includes, as shown in FIG. 1, a processing element 14. This processing element 14 is configured:
to deduce, from the sequence of pulses identified, a time (or moment), referred to as the reception time tR (FIG. 7), at which the first pulse in the sequence of pulses identified is received; and
to calculate the duration T0 between the emission time tE (at which this first pulse was emitted) and this reception time tR (with T0=tR−tE).

This duration T0 can be used to deduce therefrom various items of information and in particular to make a calculation of distance. To do this, in a preferred embodiment, the data processing unit 12 includes a processing element 15. This processing element 15 is configured to calculate, in the usual fashion; by means of this duration T0 between the emission time tE, and the reception time tR (received from the processing element 14), taking into account the speed c of light, the distance D0 between the station 2 comprising the emitting/receiving unit 3 and the object 9 that received the laser pulses emitted and returned them (FIG. 1), from the equation D0=c·T0/2. The processing element 15 thus uses a telemetry function, measuring the distance between the station 2 and the object 9.

In a variant or as a complement of the processing element 15, the data processing unit 12 includes a processing element 16. This processing element 16 is configured to analyse at least one set of pulses EI1 emitted and the corresponding sequence of pulses (received). This sequence of pulses results, for example, from a modulation and a retroreflection implemented on the object 9. From this analysis, the processing element 16 is able to deduce, in a usual fashion, various items of information. This particular embodiment can, for example, be used in the context of a laser communication link between the station 2 and the object 9, for example a drone or an object in orbit in space.

The duration of firing TR (between two sets of pulses EI1 emitted successively) is greater than a duration of round-trip movement of a set of laser pulses between the station 2 comprising the emitting/receiving unit 3 and the object 9 receiving the laser pulses emitted 1.0 and returning them. By way of illustration, this duration of round-trip movement may be between 1 and 5 milliseconds.

The data processing unit 12 can transmit the results of its processing operations, for example the distance calculated by the processing element 15 and/or the information deduced by the processing element 16, to a user system (not shown) via a connection 19.

Moreover, in a particular embodiment, the generating unit 7 is configured to generate at least two different patterns of pulses, and the emitting module 4 is configured to emit a plurality of sets of successive pulses that are in accordance with these different patterns of pulses, generated by the generating unit 7. In this particular embodiment, the processing operations performed by the data processing unit 12 are similar to the aforementioned ones, taking account simply of the difference between the patterns of pulses used.

Moreover, in a particular embodiment (shown in FIG. 1), the generating unit 7, the memory 11 and the data processing unit 12 form part of a central unit 17 of the system 1.

The system 1 also includes at least one filtering unit 18 preferably forming part of the emitting/receiving unit 3. The filtering unit 18 is configured to perform filterings, and at least one frequency filtering, of the light pulses detected by the receiving module 6, in order to keep (with a view to processing thereof by the data processing unit 12) only the light pulses detected that have frequencies situated in domains defined around the frequency or frequencies of the laser pulses emitted by the emitting module 4.

The system 1 (for emitting and receiving laser pulses), as described above, is highly advantageous. In particular, it makes it possible to reduce the energy of each laser pulse (for example to 10 μJ), to distribute the energy in a plurality of laser pulses (forming the set of pulses EI1) and to sign these pulses timewise (in accordance with the pattern of pulses in question, for example M1 or M2). This makes it possible to emit at a higher firing rate TR in order to improve the probability of detection, while keeping the required precision in the case of telemetry, and maintaining a low average energy of the laser pulses emitted, which is advantageous in terms of ocular safety.

Furthermore, it is possible to increase the resolution by increasing the number of pulses and/or by reducing the size of the correlation window F.

The system 1 as described above is able to implement a method for emitting and receiving laser pulses at high frequency.

This method for emitting and receiving laser pulses includes, as shown in FIG. 8 (related to FIG. 1), the following steps:
a generating step E1, implemented by the generating unit 7, to generate a pattern of pulses M1, M2 comprising at least three successive pulses;
an emitting step E2, implemented by the emitting module 4 of the emitting/receiving unit 3, consisting in emitting at least one set of pulses EI1 and preferably a plurality of sets of pulses EI1, a set of pulses EI1 comprising a sequence of laser pulses in accordance with said pattern of pulses used, and recording (in the memory 11) the time (or moment) referred to as the emission time tE, at which the first pulse I1 of said set of pulses EI1 is emitted;
a receiving step E3, implemented by the receiving module 6 of the emitting/receiving unit 3, consisting in receiving the light pulses ILi and recording the so-called reception times tRi at which the light pulses ILi are received; and
an analysis step E4 performed by the data processing unit 12, consisting in analysing at least the durations between the times tRi of reception of the light pulses ILi received by the receiving module 6, in order to identify a sequence of light pulses received, which is in accordance with the pattern of pulses M1, M2 used during emission. To do this, the analysis step E4 makes a correlation, implemented by the processing element 13, between said pattern of pulses M1, M2 and the light pulses ILi received, on a correlation window F, in order to identify a sequence of light pulses received, which is in accordance with said pattern of pulses M1, M2.

The analysis step E4 also consists in deducing, from the sequence of pulses thus identified, a so-called reception time tR at which the first pulse I1 in said sequence of pulses identified is received, and calculating the duration T0 between said emission time tE and said reception time tR.

In a preferred embodiment, the analysis step E4 consists in determining, by means of the duration T0 (thus calculated) between the emission time tE and the reception time tR, a distance D0 between the station 2 comprising the emitting/receiving unit 3 and the object 9 that received the laser pulses emitted and that returned them.

In a variant or as a complement, the analysis step E4 may consist in analysing at least one set of pulses emitted and the corresponding sequence of pulses received, resulting for example from a modulation and a retroreflection, in order to deduce therefrom information, for example in the context of a laser communication connection.

Numerous applications are possible for such a system 1 (for emitting and receiving laser pulses), equally well land, sea and/or air (or space) applications, with in particular transmissions at great distances (greater than ten kilometres).

According to a first application, the system 1, as described above, forms part of a high-frequency laser telemeter (not shown) that can be employed in various uses in the space field. In this application, the telemeter uses in particular the distance between the (measuring) station 2 and the object 9, as determined by the processing element 15 of the processing unit 12.

Such a laser telemeter can, in particular, by used for implementing laser trajectography via laser telemetry on a satellite (of the SLR type, standing for Satellite Laser Ranging), in particular in order to very precisely determine the orbits of space objects (satellites, debris).

Moreover, in another possible application, the system 1 (for emitting and receiving laser pulses) is used for effecting a high-frequency laser (communication) connection between the station 2, for example on the ground, and an object 9; for example a drone, using modulated-retroreflector technology. To do this, the system 1 illuminates a retroreflector mounted on the object 9. This retroreflector is designed to modulate the reflected intensity. It is produced, for example, in the form of a cube corner or a spherical reflector, so that the laser pulse returned is reflected exactly in the same direction as that of the laser pulse received. The modulation is detected and processed by the system 1, for example by means of the processing element 16, in order to deduce therefrom the corresponding information.

The system 1 can also be used, in another application, to implement the active locking of targets at very long distance.

What is claimed is:

1. Method for emitting and receiving laser pulses,
including at least the following steps:
a step (E1) of generating at least two different patterns of pulses (M1, M2), implemented by a generating unit (7), each of said different patterns of pulses (M1, M2) comprising at least three successive pulses (I1, I2, I3, I4), two successive pulses in each of said different patterns of pulses (M1, M2) being on each occasion separated in time by an associated separation duration (T1, T2, T3), the various separation durations (T1, T2, T3) of each of said different patterns of pulses (M1, M2) being variable and in accordance with a given model;
an emitting step (E2), implemented by an emitting/receiving unit (3), consisting in emitting a plurality of successive sets of pulses (EI1) that are in accordance with different patterns of pulses (M1, M2), generated at the generating step (E1), at least one of said successive sets of pulses (EI1) comprising a sequence of laser pulses in accordance with one of said different patterns of pulses (M2), and recording at least the so-called emission time (tE) at which the first pulse (I1) in the sequence of laser pulses of each of said successive sets of pulses (EI1) is emitted;
a receiving step (E3) implemented by the emitting/receiving unit (3), consisting in receiving light pulses (ILi) and recording the so-called reception times (tRi) at which these light pulses (ILi) are received; and
an analysis step (E4) implemented by a data processing unit (12), consisting at least in analysing the durations between the times of reception (tRi) of the light pulses (ILi) received at the reception step (E3) in order to identify a sequence of light pulses received, which is in accordance with one of said different patterns of pulses (M1, M2).

2. Method according to claim 1,
wherein the analysis step (E4) consists in deducing, from said sequence of pulses identified, a so-called reception time (tR) at which the first pulse (I1) in said sequence of pulses identified is received, and calculating the duration between said emission time (tE) and said reception time (tR).

3. Method according to claim 2,
wherein the analysis step (E4) consists in determining, by means of said duration between the emission time (tE) and the reception time (tR), a distance between a station (2) comprising the emitting/receiving unit (3) and an object (9) receiving the laser pulses emitted and returning them.

4. Method according to claim 1, wherein the analysis step (E4) consists in analysing at least one set of pulses emitted and the corresponding sequence of pulses received, in order to deduce information therefrom.

5. Method according to claim 1, wherein the analysis step (E4) consists in making a correlation between said pattern of pulses (M1, M2) and the light pulses (ILi) received on a correlation window (F), in order to identify the sequence of light pulses received, which is in accordance with said pattern of pulses (M1, M2).

6. Method according to claim 1, wherein the emitting step (E2) consists in successively emitting a plurality of sets of pulses (EI1).

7. Method according to claim 6,
wherein the duration (TR) between two sets of pulses (EI1) emitted successively is greater than a duration of round-trip movement of a set of pulses (E1) between a station (2) comprising the emitting/receiving unit (3) and an object (9) receiving the laser pulses emitted and returning them.

8. System for emitting and receiving laser pulses, comprising:
a generating unit (7) configured to generate at least two different patterns of pulses (M1, M2), each of said different patterns of pulses (M1, M2) comprising at least three successive pulses (I1, I2, I3, I4), two successive pulses of each of said different patterns of pulses (M1, M2) being on each occasion separated in time by an associated separation duration (T1, T2, T3), the various separation durations (T1, T2, T3) of each of said different patterns of pulses (M1, M2) being variable and in accordance with a given model;
an emitting/receiving unit (3) that is configured to:
emit a plurality of successive sets of pulses (EI1) that are in accordance with different patterns of pulses (M1, M2), generated by the generating unit (7), at least one set of said successive sets of pulses (EI1) comprising a sequence of laser pulses in accordance with one of said different patterns of pulses (M1, M2); and
receiving light pulses (ILi);
at least one memory (11) configured to record at least the so-called reception times (tRi) at which the light pulses (ILi) are received by the emitting/receiving unit (3); and
a data processing unit (12) configured at least to analyse the durations between the reception times (tRi) of receiving the light pulses (ILi) in order to identify a sequence of light pulses received, which is in accordance with one of said different patterns of pulses (M1, M2).

9. System according to claim 8,
further comprising at least one filtering unit (18) configured to perform at least one frequency filtering of the light pulses received, in relation to the frequency or frequencies of the laser pulses emitted.
